(19) United States
(12) Patent Application Publication
(10) Pub. No.: US 2026/0158944 A1
(43) Pub. Date: Jun. 11, 2026

(54) Charging Socket Integrated with Electronic Lock

(71) Applicants: Tyco Electronics (Shanghai) Co., Ltd., Shanghai (CN); Tyco Electronisc Technology (SIP) Co., Ltd., Suzhou (CN)

(72) Inventors: Fangyue (Jason) Zhu, Shanghai (CN); Jiachen (Allen) Zhang, Suzhou (CN); Yuanlu Hu, Suzhou (CN); Leilei Xia, Shanghai (CN); Qun (Sunny) Zhang, Suzhou (CN)

(73) Assignees: Tyco Electronics (Shanghai) Co., Ltd., Shanghai (CN); Tyco Electronisc Technology (SIP) Co., Ltd., Suzhou (CN)

(21) Appl. No.: 19/416,175

(22) Filed: Dec. 11, 2025

(30) Foreign Application Priority Data
Dec. 11, 2024 (CN) 202411824738.X
Dec. 11, 2024 (CN) 202423062463.9

(51) Int. Cl. B60L 53/16

(52) U.S. Cl. CPC B60L 53/16

(57) ABSTRACT

A charging socket integrated with an electronic lock. The charging socket includes a socket housing and a socket assembly. The socket assembly is provided within the socket housing. The socket assembly includes a printed circuit board. The electronic lock is electrically connected to the printed circuit board of the socket assembly.

### CROSS-REFERENCE TO RELATED APPLICATION

This application claims the benefit of the filing date under 35 U.S.C. § 119(a)-(d) of Chinese Patent Applications No. CN 202411824738.X and CN 202423062463.9 filed on Dec. 11, 2024, the whole disclosures of which are incorporated herein by reference.

### FIELD OF THE INVENTION

The present invention relates to the technical field of electric vehicle accessories and, more particularly, to a charging socket integrated with an electronic lock.

### BACKGROUND OF THE INVENTION

With the development of the new energy industry, electric vehicles are becoming increasingly popular in the market, and a charging device is an essential component in electric vehicle production. The electric vehicles are generally equipped with a charging socket for connecting with a charging gun to charge the onboard battery. In order to prevent the charging gun from accidentally separating from the charging socket during charging, an electronic lock is typically installed on the charging socket. During charging, the electronic lock locks the charging gun when inserted into the charging socket.

In the existing structure of the charging socket, the electronic lock is typically provided outside of the charging socket and connected to a vehicle body assembly via a wire. In the existing structure, the wire connected to the electronic lock is exposed to the outside, and waterproof and other safety requirements need to be considered, such that higher requirements for the sealing structure is needed, resulting in higher overall cost.

### SUMMARY OF THE INVENTION

A charging socket integrated with an electronic lock. The charging socket includes a socket housing and a socket assembly. The socket assembly is provided within the socket housing. The socket assembly includes a printed circuit board. The electronic lock is electrically connected to the printed circuit board of the socket assembly.

### BRIEF DESCRIPTION OF DRAWINGS

The invention will now be described by way of example with reference to the accompanying figures, of which:

FIG. 1 is a perspective view of a charging socket integrated with an electronic lock according to an exemplary embodiment;

FIG. 2 is a perspective view of the charging socket of FIG. 1 integrated with the electronic lock of FIG. 1, in which a second housing is omitted;

FIG. 3 is a perspective view of a connection between the electronic lock of FIG. 1 inside the charging socket of FIG. 1 and a printed circuit board according to an exemplary embodiment;

FIG. 4 is a cross-sectional view of the connection between the electronic lock of FIG. 1 inside the charging socket of FIG. 1 and the printed circuit board of FIG. 3; and

FIG. 5 is another cross-sectional view of the connection between the electronic lock of FIG. 1 inside the charging socket of FIG. 1 and the printed circuit board of FIG. 3.

### DETAILED DESCRIPTION

The technical solution of the present disclosure is further specifically described below through embodiments and in combination with the accompanying drawings. In the description below, the same or similar parts are indicated by the same or similar reference numerals. The description of each of the embodiments of the present disclosure hereinafter with reference to the accompanying drawings is intended to explain the general inventive concept of the present disclosure and should not be construed as a limitation on the present disclosure.

In addition, in the following detailed description, for the sake of explanation, numerous specific details are set forth in order to provide a thorough understanding of the disclosed embodiments. It will be apparent, however, that one or more embodiments may also be practiced without these specific details. In other instances, well-known structures and devices are illustrated schematically in order to simplify the drawing.

The present disclosure relates to a charging socket integrated with an electronic lock, which is particularly applied for the charging needs of electric vehicles.

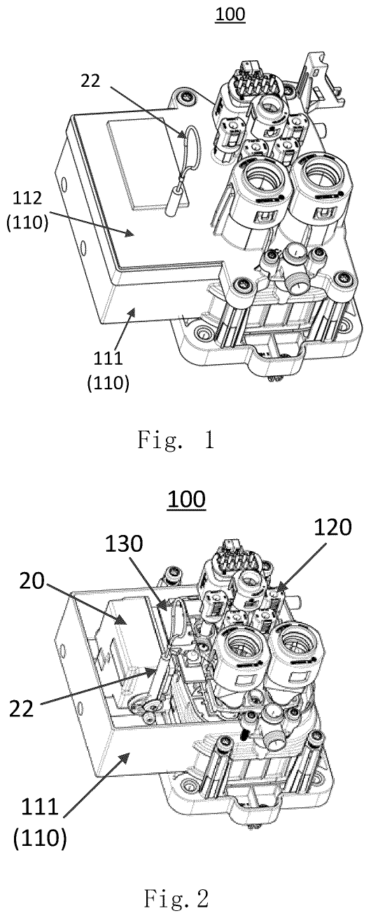

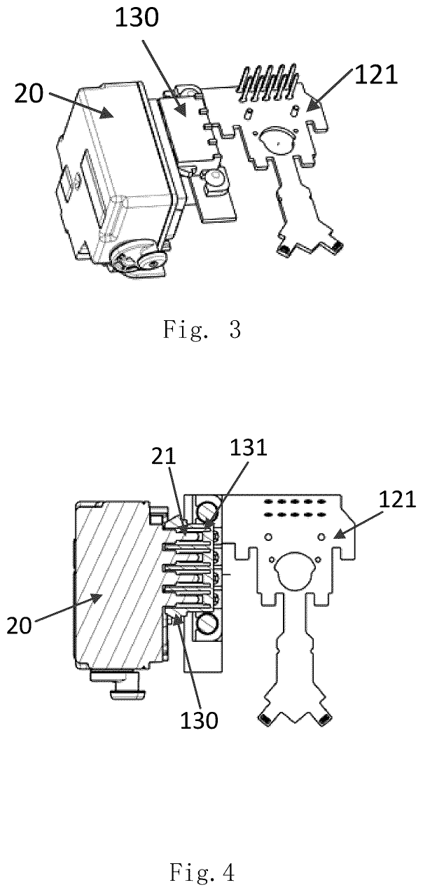

An exemplary embodiment of a charging socket 100 integrated with an electronic lock 20 will now be described with reference to FIGS. 1-5. The charging socket 100 includes a socket housing 110, as shown in FIGS. 1-2, and a socket assembly 120, as shown in FIG. 2, provided within the socket housing 110. The electronic lock 20 is provided inside the socket housing 110 for controlling insertion and removal of a charging plug. As shown in FIGS. 3-5, the electronic lock 20 is electrically connected to a printed circuit board 121 of the socket assembly 120.

The socket assembly 120 is a core part of the charging socket 100, and includes the printed circuit board 121 and other necessary components required for the charging socket 100 to achieve its purpose (e.g., including but not limited to signal terminals and charging terminals). The printed circuit board 121 is provided with a circuit for charging control and signal processing(s). The printed circuit board 121 is securely mounted on a socket bracket of the socket assembly 120 by a fastener to ensure its stability and reliability.

According to the design concept of the present disclosure, the electronic lock 20 is provided inside the socket housing 110 and electrically connected to the printed circuit board 121 of the socket assembly 120. The electronic lock 20 may be electrically connected to an electronic lock printed circuit in the printed circuit board 121, such as a dedicated printed circuit for signal/power transmission(s) of the electronic lock 20.

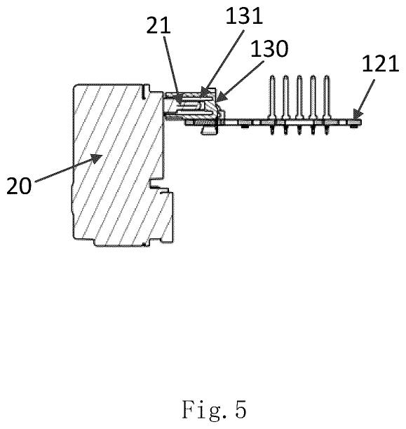

In order to achieve the electrical connection between the electronic lock 20 and the printed circuit board 121, an electrical connector 130, as shown in FIGS. 2-5, is adopted in the exemplary embodiment of the present disclosure. As shown in FIGS. 2-5, the charging socket 100 further includes the electrical connector 130. The electronic lock 20 is electrically connected to the printed circuit board 121 via the electrical connector 130. Specifically, according to the exemplary embodiments, the electronic lock 20 has a pin terminal(s) 21, as shown in FIGS. 4-5, for being connected to the electrical connector 130 in a plug-in manner. The electrical connector 130 is preferably a socket connector, which is provided with a connection terminal(s) 131, as shown in FIGS. 4-5, that is positioned inside the connector and mated with the pin terminal(s) 21. When the pin terminal(s) 21 of the electronic lock 20 is inserted into the electrical connector 130, they make tight contact with the connection terminal(s) 131, thereby achieving an electrical connection between the electronic lock 20 and the printed circuit board 121. The connection terminals 131 are further connected to the electronic lock-specific printed circuit in the printed circuit board 121, via a wire or by soldering, and so on. As described above, the electronic lock-specific printed circuit is a dedicated printed circuit designed specifically for the electronic lock 20, which is used for signal and power transmission(s) of the electronic lock 20. Furthermore, in order to ensure the stability and reliability of the electrical connector 130, the electrical connector 130 is secured to the printed circuit board 121 by a fastener (such as screw(s), clip(s), etc.). Of course, in other exemplary embodiments of the present disclosure, the electrical connector 130 may also be in other forms of electrical connector, such as a crimping connector. Furthermore, in other embodiments of the present disclosure, the electronic lock 20 may also be electrically connected to the printed circuit board 121 via a wire.

As shown in FIGS. 1-2, the charging socket 100 mainly includes a socket housing 110 and a socket assembly 120 provided within the socket housing 110. The socket housing 110 is designed to be robust and waterproof to protect its internal electrical element from be damaged by a external environment. Specifically, as shown in FIG. 1, the socket housing 110 includes a first housing 111 and a second housing 112 that is engaged with the first housing 111 in a sealed manner (e.g., by means of a sealing ring, etc.). This design ensures the sealing of the inside of the socket, preventing moisture and dust from entering it.

In order to ensure the stability and reliability of the electronic lock 20 within the charging socket 100, the electronic lock 20 is also secured to the socket bracket of the socket assembly 120 by fastener(s) (such as screw(s), nut(s), etc.). This securing method not only ensures the stability of the electronic lock 20 during charging but also prevents it from loosening or being damaged during long-term use.

As shown in FIGS. 1-2, the electronic lock 20 also has a manual pulling ring 22, which is designed for manually unlocking the electronic lock 20 when needed. To facilitate user operation, the manual pulling ring 22 is led out of the socket housing 110, specifically, out of the second housing 112. In this way, the user is allowed to easily unlock the electronic lock 20 by the manual pulling ring 22 without disassembling the socket housing 110.

According to the charging socket 100 integrated with the electronic lock 20 provided by the aforementioned exemplary embodiments of the present disclosure, the electronic lock 20 is integrated into the socket housing 110 and is electrically connected to the printed circuit board 121 of the socket assembly 120, which avoids the use of wire to connect the electronic lock 20 to the vehicle body, and thus not only saves the cost but also improves the integration of the charging socket 100.

It should be appreciated by those skilled in the art that the above embodiments are intended to be illustrative, and many modifications may be made to the above embodiments by those skilled in the art. Further, various structures described in various embodiments may be freely combined with each other without conflicting in configuration or principle.

Although the present disclosure has been described hereinbefore in detail with reference to the accompanying drawings, it should be appreciated that the disclosed embodiments in the accompanying drawings are intended to illustrate the embodiments of the present disclosure by way of example, and should not be construed as limitation to the present disclosure.

Although some embodiments of the present disclosure have been shown and described, it would be appreciated by those skilled in the art that changes or modification may be made to these embodiments without departing from the principles and spirit of the general inventive concept, the scope of which is defined in claims and their equivalents.

It should be noted that, the word “comprise” or “include” doesn't exclude other elements or steps, and the word “a” or “an” doesn't exclude more than a plurality. In addition, any reference numerals in the claims should not be interpreted as a limitation to the scope of the present disclosure.

1. A charging socket integrated with an electronic lock, the charging socket comprising:
a socket housing; and
a socket assembly provided within the socket housing, the electronic lock is electrically connected to a printed circuit board of the socket assembly.

2. The charging socket integrated with the electronic lock of claim 1, wherein the charging socket has an electrical connector.

3. The charging socket integrated with the electronic lock of claim 2, wherein the electronic lock is electrically connected to the printed circuit board via the electrical connector.

4. The charging socket integrated with the electronic lock of claim 3, wherein the electronic lock has a pin terminal, and the electrical connector is a socket connector.

5. The charging socket integrated with the electronic lock of claim 4, wherein the pin terminal is connected to a connection terminal in the socket connector in a plug-in manner, and the connection terminal is electrically connected to an electronic lock printed circuit in the printed circuit board.

6. The charging socket integrated with the electronic lock of claim 5, wherein the electronic lock printed circuit is a dedicated printed circuit for signal transmission and/or power transmission of the electronic lock.

7. The charging socket integrated with the electronic lock of claim 2, wherein the electrical connector is fixed to the printed circuit board by a fastener.

8. The charging socket integrated with the electronic lock of claim 1, wherein the electronic lock is provided inside the socket housing.

9. The charging socket integrated with the electronic lock of claim 1, wherein the electronic lock has a manual pulling ring, the manual pulling ring is led out of the socket housing.

10. The charging socket integrated with the electronic lock of claim 9, wherein the socket housing includes a first housing and a second housing engaged with the first housing in a sealed manner.

11. The charging socket integrated with the electronic lock of claim 10, wherein the manual pulling ring is led out of the second housing.

12. The charging socket integrated with the electronic lock of claim 1, wherein the electronic lock is fixed to a socket bracket of the socket assembly by a fastener.

13. The charging socket integrated with the electronic lock of claim 1, wherein the charging socket integrated with the electronic lock is a charging socket for an electric vehicle.
